(19) United States
(12) Patent Application Publication
(10) Pub. No.: US 2023/0078545 A1
(43) Pub. Date: Mar. 16, 2023

(54) RESOLVING A FAILURE IN COMMUNICATION WITHIN A WIRELESS BATTERY MANAGEMENT SYSTEM OF A VEHICLE

(71) Applicant: SENSATA TECHNOLOGIES, INC., ATTLEBORO, MA (US)

(72) Inventors: JONATHAN M. RIGELSFORD, SHEFFIELD (GB); JING DENG, BELFAST (GB); LUIS ESPAILLAT, NORTH ATTLEBORO, MA (US)

(21) Appl. No.: 17/799,771

(22) PCT Filed: Feb. 8, 2021
(86) PCT No.: PCT/US2021/017067

§ 371 Date: Aug. 15, 2022

Related U.S. Application Data
(60) Provisional application No. 62/976,821, filed on Feb. 14, 2020.

(51) Int. Cl. B60L 58/10; H04L 1/00; H04W 52/02

(52) U.S. Cl. CPC B60L 58/10; H04L 1/0015; H04W 52/0245

(57) ABSTRACT

Methods, apparatuses, systems, devices, and non-transitory for resolving a failure in communication within a wireless battery management system (BMS) of a vehicle are disclosed. In a particular embodiment, a wireless network controller (WNC) of a wireless BMS determines that there is a failure in communication between the WNC and one or more module measurement systems (MMS). The WNC also determines a background radio frequency (RF) power level of a communication channel between the WNC and the one or more MMS and based on the determined background RF power level, selects one or more actions to perform in an attempt to correct the failure in communication between the WNC and the one or more MMS. In this particular embodiment, the WNC performs the selected one or more actions in an attempt to correct the failure in communication.

### BACKGROUND

Vehicle sensor systems often use wireless communication to facilitate communication between vehicle sensors and control systems. When there is a loss of communication between sensors and control systems, safety measures must be implemented to place the vehicle into a safe operating state, which may include stopping the vehicle, limiting the vehicle acceleration, limiting a maximum speed, and/or other safety precautions. The safe operating state is maintained until the vehicle can be serviced. However, in many situations, the failure in communication may be temporary, and the cause be remedied without the need for placing the vehicle into a safe operating state.

### SUMMARY OF INVENTION

Methods, apparatuses, systems, devices, and non-transitory computer program products for resolving a failure in communication within a wireless battery management system (BMS) of a vehicle are disclosed. In a particular embodiment, a wireless network controller (WNC) of a wireless BMS determines that there is a failure in communication between the WNC and one or more module measurement systems (MMS) of the BMS. In this example embodiment, the WNC determines a background radio frequency (RF) power level of a communication channel between the WNC and the one or more MMS and based on the determined background RF power level, selects one or more actions to perform in an attempt to correct the failure in communication between the WNC and the one or more MMS. In this particular embodiment, the WNC performs the selected one or more actions in an attempt to correct the failure in communication.

In a particular embodiment, a wireless battery management system (BMS) is disclosed that includes one or more module measurement systems (MMS), which are configured to monitor a plurality of cells of a battery pack. The wireless BMS also includes a wireless network controller (WNC) that includes a processor and memory operatively coupled to the processor, the memory having disposed within it computer program instructions that, when executed by the processor, cause the WNC to carry out operations. In this example embodiment, the operations include determining that there is a failure in communication between the WNC and the one or more MMS; determining a background radio frequency (RF) power level of a communication channel between the WNC and the one or more MMS; based on the determined background RF power level, selecting one or more actions to perform in an attempt to correct the failure in communication between the WNC and the one or more MMS; and performing the selected one or more actions in an attempt to correct the failure in communication.

In another embodiment, a non-transitory computer readable storage medium is disclosed that includes computer program instructions that when executed by a processor of a wireless network controller (WNC) of a wireless battery management system (BMS), cause the WNC to carry out operations. In this embodiment, the operations includes determining that there is a failure in communication between WNC and one or more module measurement systems (MMS) of the wireless BMS, the one or more MMS configured to monitor a plurality of cells of a battery pack; determining a background radio frequency (RF) power level of a communication channel between the WNC and the one or more MMS; based on the determined background RF power level, selecting one or more actions to perform in an attempt to correct the failure in communication between the WNC and the one or more MMS; and performing the selected one or more actions in an attempt to correct the failure in communication.

By utilizing the background RF power level to select one or more activities to perform in an attempt to correct the failure in communication within the BMS, the WNC may have a chance of identifying activities that have the best chance of correcting the failure. Performing the selected one or more activities may resolve the failure, such that communication between the WNC and the one or more MMS may resume before a fault tolerant time interval for the vehicle expires. In such instances, the failure in communication is resolved without needing to place the vehicle in a safe operating state.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF DRAWINGS

FIG. 1 sets forth a block diagram of a battery pack apparatus that includes a wireless battery management system configured to resolve a failure in communication within the wireless battery management system in accordance with at least one embodiment of the present disclosure;

FIG. 2 illustrates a block diagram of a module monitoring system of a wireless battery management system configured to resolve a failure in communication within the wireless battery management system in accordance with at least one embodiment of the present disclosure;

FIG. 3 illustrates a block diagram of a wireless network controller of a wireless battery management system configured to resolve a failure in communication within the wireless battery management system in accordance with at least one embodiment of the present disclosure;

FIG. 4 is a flowchart to illustrate an implementation of a method of resolving a failure in communication within a wireless battery management system in accordance with at least one embodiment of the present disclosure:

FIG. 5 is a flowchart to illustrate an implementation of a method of resolving a failure in communication within a wireless battery management system in accordance with at least one embodiment of the present disclosure:

FIG. 6 is a flowchart to illustrate an implementation of a method of resolving a failure in communication within a wireless battery management system in accordance with at least one embodiment of the present disclosure;

FIG. 7 is a flowchart to illustrate an implementation of a method of resolving a failure in communication within a wireless battery management system in accordance with at least one embodiment of the present disclosure:

FIG. 8 is a flowchart to illustrate an implementation of a method of resolving a failure in communication within a wireless battery management system in accordance with at least one embodiment of the present disclosure;

FIG. 9 is a flowchart to illustrate an implementation of a method of resolving a failure in communication within a wireless battery management system in accordance with at least one embodiment of the present disclosure:

FIG. 10 is a flowchart to illustrate an implementation of a method of resolving a failure in communication within a wireless battery management system in accordance with at least one embodiment of the present disclosure;

FIG. 11 is a flowchart to illustrate an implementation of a method of resolving a failure in communication within a wireless battery management system in accordance with at least one embodiment of the present disclosure:

FIG. 12 is a flowchart to illustrate an implementation of a method of resolving a failure in communication within a wireless battery management system in accordance with at least one embodiment of the present disclosure:

FIG. 13 is a flowchart to illustrate an implementation of a method of resolving a failure in communication within a wireless battery management system in accordance with at least one embodiment of the present disclosure;

FIG. 14 is a flowchart to illustrate an implementation of a method of resolving a failure in communication within a wireless battery management system in accordance with at least one embodiment of the present disclosure;

FIG. 15 is a flowchart to illustrate an implementation of a method of resolving a failure in communication within a wireless battery management system in accordance with at least one embodiment of the present disclosure;

FIG. 16 is a flowchart to illustrate an implementation of a method of resolving a failure in communication within a wireless battery management system in accordance with at least one embodiment of the present disclosure:

FIG. 17 is a flowchart to illustrate an implementation of a method of resolving a failure in communication within a wireless battery management system in accordance with at least one embodiment of the present disclosure;

FIG. 18 is a flowchart to illustrate an implementation of a method of resolving a failure in communication within a wireless battery management system in accordance with at least one embodiment of the present disclosure; and

FIG. 19 is a flowchart to illustrate an implementation of a method of resolving a failure in communication within a wireless battery management system in accordance with at least one embodiment of the present disclosure.

### DESCRIPTION OF EMBODIMENTS

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

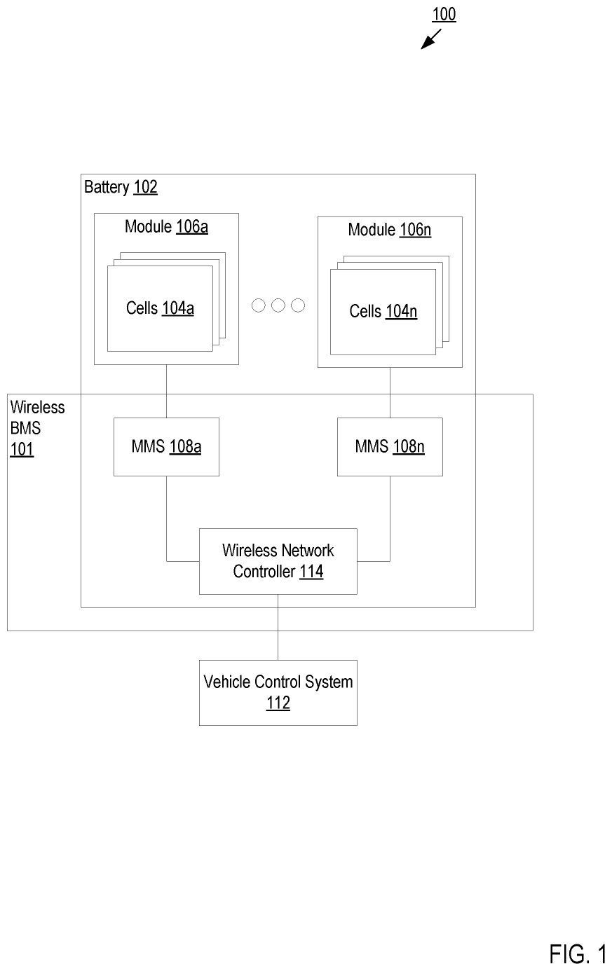

Exemplary methods, apparatus, devices, and computer program products for determining a communication disruption for wireless battery management systems in accordance with the present invention are described with reference to the accompanying drawings, beginning with FIG. 1. For further explanation, FIG. 1 sets forth a block diagram of a battery pack apparatus (100) that includes a wireless battery management system (BMS) (101) configured to resolve a failure in communication within the wireless BMS (101) in accordance with at least one embodiment of the present disclosure. The battery pack apparatus (100) includes a battery (102), such as a high voltage battery for use in an electric vehicle. The battery (102) includes a plurality of cells (104a-n), such as Lithium-ion (Li-ion) cells. The cells (104a-n) are grouped into modules (106a-n) such that each module (106a-n) comprises a corresponding subset of the cells (104a-n). The cells (104a-n) may be physically grouped into modules (106a-n) using a casing, chassis, or other enclosure. The cells (104a-n) may also be logically grouped into modules (106a-n) by virtue of distinct groupings of cells (104a-n) being monitored by a distinct module monitoring system (108a-n).

The battery pack apparatus (100) also includes a plurality of module monitoring systems (MMS) (108a-n). Each MMS (108a-n) is configured to monitor a corresponding module (106a-n) of cells (104a-n). For example, each module (106a-n) may have a MMS (108a-n) attached to a chassis, base, tray, or other mechanism holding the cells (104a-n) of the module (106a-n). Each MMS (108a-n) includes sensors to measure various attributes of the cells (104a-n) of its corresponding module (106a-n). Such attributes may include voltage, current, temperature, and potentially other attributes. The attributes are indicated in battery sensor data generated by the MMS (108a-n).

Each MMS (108a-n) encodes its battery sensor data for transmission as a wireless signal and transmits its battery sensor data as the wireless signal to a wireless network controller (WNC) (114). The WNC (114) may then provide the battery sensor data to a vehicle control system (112).

In a particular embodiment, the WNC (114) determines that there is a failure in communication between the WNC (114) and one or more MMS of the MMS (108a-n). The WNC (114) also determines a background radio frequency (RF) power level of a communication channel between the WNC (114) and the one or more MMS of the MMS (108a-n) and based on the determined background RF power level, selects one or more actions to perform in an attempt to correct the failure in communication between the WNC (114) and the one or more MMS (108a-n). In this particular embodiment, the WNC (114) performs the selected one or more actions in an attempt to correct the failure in communication.

By utilizing the background RF power level to select one or more activities to perform in an attempt to correct the failure in communication within the BMS, the WNC may have a chance of identifying activities that have the best chance of correcting the failure. Performing the selected one or more activities may resolve the failure, such that communication between the WNC and the one or more MMS may resume before a fault tolerant time interval for the vehicle expires. In such instances, the failure in communication is resolved without needing to place the vehicle in a safe operating state.

The arrangement of components and devices making up the exemplary system illustrated in FIG. 1 are for explanation, not for limitation. The BMS (103) may support various communication protocols, such as IEEE 802.11, WAP (Wireless Access Protocol), Bluetooth, and others as will occur to those of skill in the art. Various embodiments of the present invention may be implemented on a variety of hardware platforms in addition to those illustrated in FIG. 1.

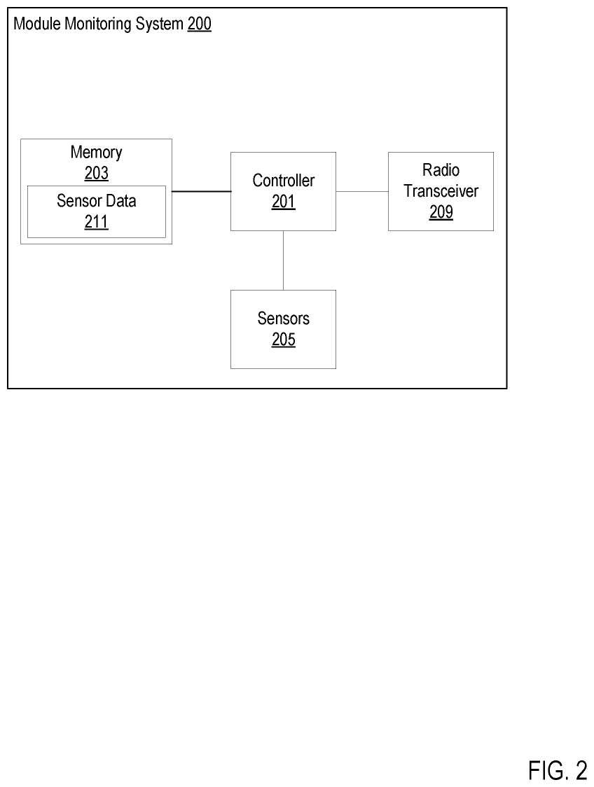

For further explanation, FIG. 2 sets forth a block diagram of a module monitoring system (MMS) (200) (e.g., a module monitoring system (108a-n) of FIG. 1) of a wireless battery management system (BMS) (e.g., the BMS (101) of FIG. 1) configured to resolve a failure in communication within the wireless BMS (101) in accordance with at least one embodiment of the present disclosure. The MMS (200) includes a controller (201) coupled to a memory (203). The controller (201) is configured to obtain sensor readings from sensors (205) (e.g., voltage sensors, temperature sensors, current sensors) to generate battery sensor data (211). The controller (201) is also configured to transmit the sensor data (211) via a radio frequency transceiver (209). The controller (201) may include or implement a microcontroller, an Application Specific Integrated Circuit (ASIC), a digital signal processor (DSP), a programmable logic array (PLA) such as a field programmable gate array (FPGA), or other data computation unit in accordance with the present disclosure. The battery sensor data (211) may be stored in the memory (203). The memory (203) may be a non-volatile memory such as flash memory.

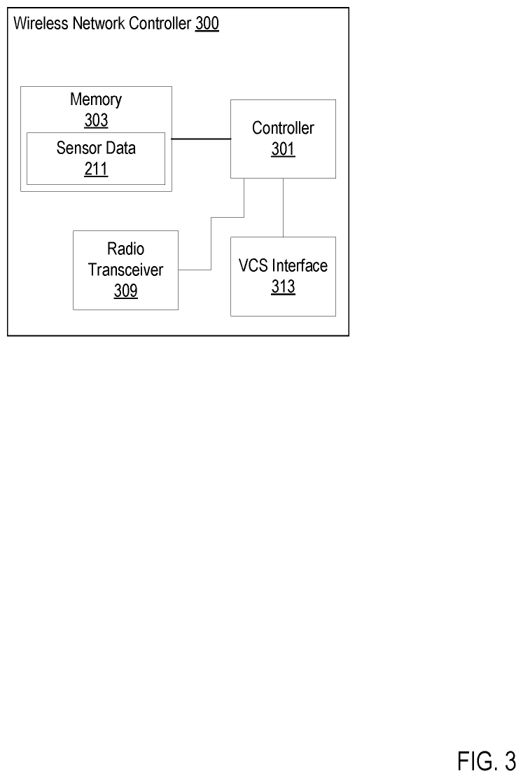

For further explanation, FIG. 3 sets forth a block diagram of a wireless network controller (WNC) (300) (e.g., the WNC (114) of FIG. 1) of a wireless BMS (e.g., the BMS (101) of FIG. 1) configured to resolve a failure in communication within the wireless battery management system (BMS) in accordance with at least one embodiment of the present disclosure. The WNC (300) includes a controller (301) coupled to a memory (303). The WNC (301) is configured to receive, via a radio transceiver (309) from a plurality of MMS (e.g., MMS (200) of FIG. 2), wireless signals encoding sensor data (311). The controller (301) may then generate sensor data (311) based on the wireless signal.

The controller (301) may include or implement a microcontroller, an Application Specific Integrated Circuit (ASIC), a digital signal processor (DSP), a programmable logic array (PLA) such as a field programmable gate array (FPGA), or other data computation unit in accordance with the present disclosure. The battery sensor data (311) may be stored in the memory (303). The memory (303) may be a non-volatile memory such as flash memory. The controller (301) may be further configured to provide sensor data to a vehicle control system (e.g., a VCS (112) of FIG. 1) via a VCS interface (313). The VCS interface (313) may include a bus or other wired connection to a VCS.

In a particular embodiment, the WNC (300) determines that there is a failure in communication between the WNC (300) and one or more MMS. The WNC (300) also determines a background radio frequency (RF) power level of a communication channel between the WNC (300) and the one or more MMS and based on the determined background RF power level, selects one or more actions to perform in an attempt to correct the failure in communication between the WNC (300) and the one or more MMS. In this particular embodiment, the WNC (300) performs the selected one or more actions in an attempt to correct the failure in communication.

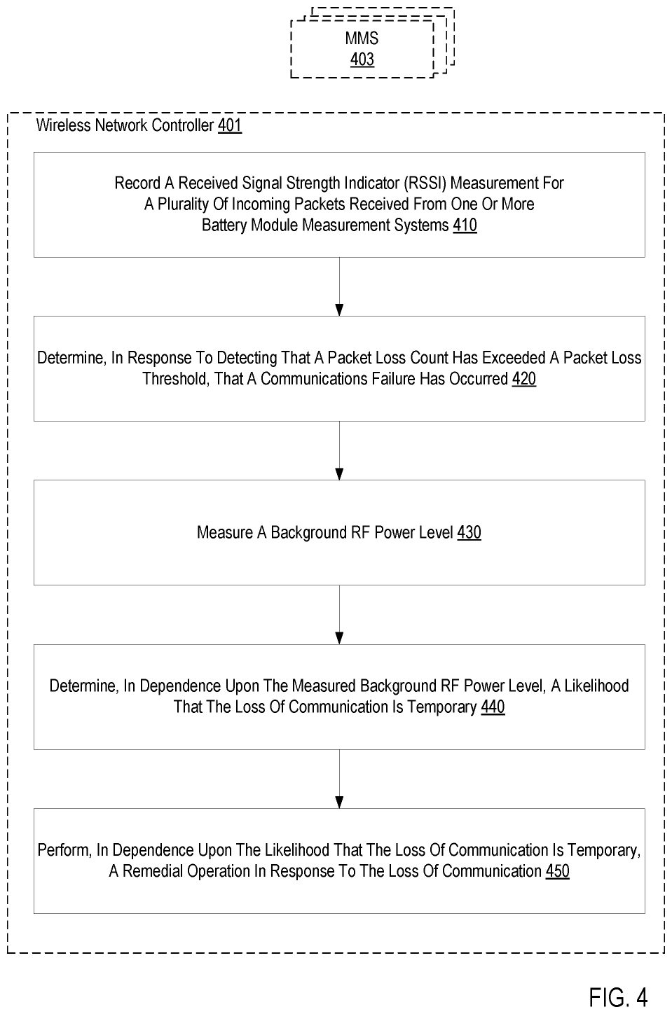

For further explanation, FIG. 4 sets forth a flowchart to illustrate an implementation of a method of resolving a failure in communication within a wireless battery management system (BMS) in accordance with at least one embodiment of the present disclosure. The method of FIG. 4 includes a wireless network controller (WNC) (401) of the wireless BMS recording (410) a received signal strength indicator (RSSI) measurement for a plurality of incoming packets received from one or more module measurement systems (MMS) (403). For example, the WNC (401) may receive packets from the MMS (403) at a regular interval (e.g., every 2 seconds). In this example, the packets may be transmitted via a radio frequency (RF) link and received by the WNC (401). Recording (410) a received signal strength indicator (RSSI) measurement for a plurality of incoming packets received from one or more MMS (403) may be carried out by the WNC (401) measuring and recording the RSSI of incoming packets received from the one or more MMS (403).

The method of FIG. 4 also includes the WNC (401) determining (420), in response to detecting that a packet loss count has exceeded a packet loss threshold, that a communications failure has occurred. A fault tolerant time interview (FTTI) may be defined, for example, in terms of time since a last packet was received or a number of packets lost (i.e., not received at the expected interval). For example, the FTTI may elapse when 10 packets are not received or when 10 seconds pass since the last packet was received. Once the FTTI has elapsed, the vehicle must be placed in the safe operating state. Determining (420), in response to detecting that a packet loss count has exceeded a packet loss threshold, that a communications failure has occurred may be carried out by the WNC (401) establishing a packet loss threshold (e.g., packet loss=3) that avoids exceeding the FTTI, and the WNC (401) determining that the number of packets expected but not received has exceeded the packet loss threshold.

The method of FIG. 4 also includes the WNC (401) measuring (430) a background RF power level. Measuring (430) the background RF power level may be carried out by the WNC (401) measuring the RF power level of a received signal at a time when a packet is not expected. For example, if a packet is expected from the MMS (403) every 2 seconds, the background RF power level (the “P_{BG}”) is measured by the WNC (401) at a time between that interval. For example, the P_{BG} may be measured at time (i.e., slot) that is reserved for channel access for BMS commands.

The method of FIG. 4 also includes the WNC (401) determining (440), in dependence upon the measured background RF power level, a likelihood that the loss of communication is temporary. Determining (440), in dependence upon the measured background RF power level, a likelihood that the loss of communication is temporary may be carried out by the WNC (401) classifying a probability level that the communication loss is temporary based on whether the P_{BG} exceeds or falls below threshold levels. The threshold levels may be based on the recorded RSSI of incoming packets from the one or more MMSs (the “P_{RX}”). The P_{RX} may be, for example, the recorded RSSI value of a packet from one MMS, an average of RSSI values from one MMS, an average of RSSI values from multiple MMSs, or a maximum recorded RSSI value.

When the P_{BG} is equal to or greater than a first threshold, the WNC (401) may classify the likelihood that the loss of communication is temporary as highly probable. The first threshold may be, for example, the P_{RX}. Thus, when P_{BG}>=P_{RX} the probability the loss of communication is high. The likelihood that the loss of communication is temporary may be highly probable in that it is highly probable that the loss of communication is due to signal interference. Thus, the interfering signal may cease or move away from the vehicle, the vehicle may move away from the interfering signal, or a denial of service (DoS) attack may abate, thus the loss of communication could be remedied before the FTI elapses.

When the P_{BG} is less than the P_{RX} but greater than or equal to a second threshold, the WNC (401) may classify the likelihood that the loss of communication is temporary as reasonably probable, in that it is reasonably probable that the loss of communication is due to signal interference. For example, the second threshold may be the P_{RX} less a power factor, such as P_{RX}−M dBm. For example, M may be equal to 6 dBm. In such a scenario where P_{BG}<P_{RX} but P_{BG}>=P_{RX}−M dBm, there is a reasonable probability that the loss of communication is temporary.

When the P_{BG} is less than a third threshold, the WNC (401) may classify the likelihood that the loss of communication is temporary as improbable. For example, the third threshold may be the P_{RX} less another power factor, such as P_{RX}−N dBm. For example, N may be equal to 10 dBm. In such a scenario where P_{BG}<P_{RX}−N dBm, it may be inferred that an interfering signal is not the cause of the loss of communication, and rather that the loss of communication is more likely due to a hardware failure.

The method of FIG. 4 also includes the WNC (401) performing (450), in dependence upon the likelihood that the loss of communication is temporary, a remedial operation (e.g., one or more actions) in response to the loss of communication. Performing (450), in dependence upon the likelihood that the loss of communication is temporary, a remedial operation in response to the loss of communication may be carried out by the WNC (401) taking remedial action based on whether it is highly probable, reasonably probable, or improbable that loss of communication is temporary. For example, if it is determined that it is highly probable that the loss of communication is temporary, the WNC (401) can attempt to remedy the loss of communication by switching to a redundant communication channel to avoid exceeding the FTTI. If it is determined that it is reasonably probable that the loss of communication is temporary, the WNC (401) can attempt to remedy the loss of communication by increasing the radio power of both the WNC (401) and the MMS (403) and reassessing the loss of communication before the FTTI elapses. If it is determined that it is improbable that the loss of communication is temporary, the WNC (401) can attempt to remedy the loss of communication by increasing the radio power of both the WNC (401) and the MMS (403) and reassessing the loss of communication before the FTTI elapses. If the FTTI elapses, the vehicle may be placed into the safe operating state.

The exemplary method of FIG. 4 may be embodied in computer program instructions stored in a memory of the WNC (401) that, when executed by a processor of the WNC (401), cause the WNC (401) to carry out the method of FIG. 4. Readers of skill in the art will recognize, however, that the present invention also may be embodied in a computer program product disposed upon computer readable storage media for use with any suitable data processing system.

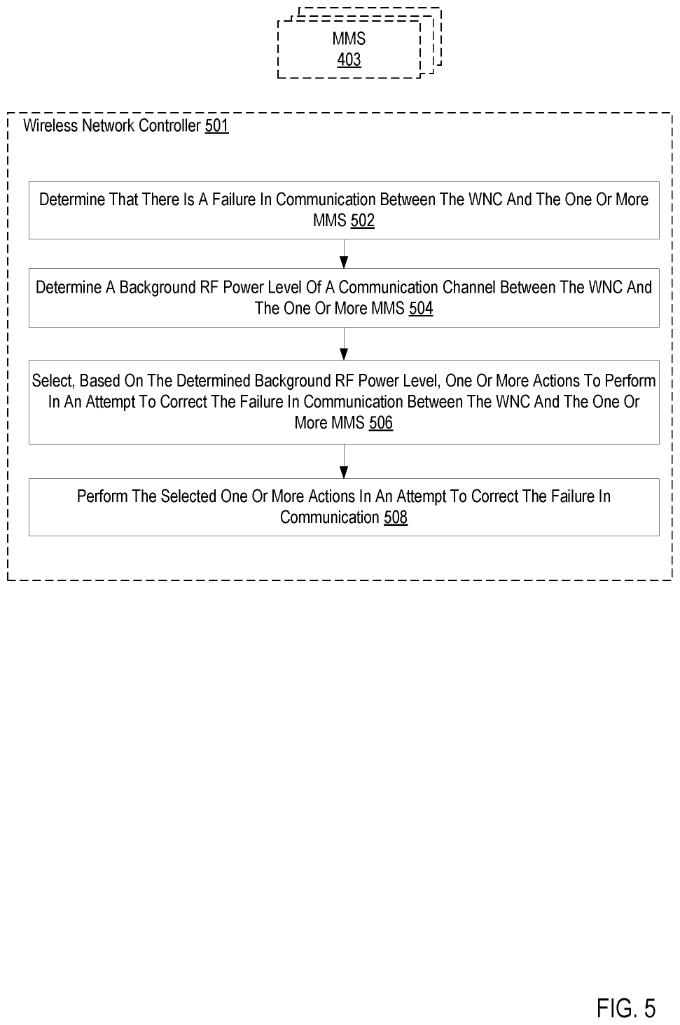

For further explanation, FIG. 5 sets forth a flowchart to illustrate an implementation of a method of resolving a failure in communication within a wireless battery management system in accordance with at least one embodiment of the present disclosure. The method of FIG. 5 includes determining (502), by the WNC (501), that there is a failure in communication between the WNC (501) and the one or more MMS (503). Determining (502), by the WNC (501), that there is a failure in communication between the WNC (501) and the one or more MMS (503) may be carried out by detecting that a packet has not been received within a set period of time; detecting that a set number of packets has not been received within a set period of time; detecting that a packet loss count has exceeded a packet loss threshold; and other methods of detecting a communication disruption.

The method of FIG. 5 also includes determining (504), by the WNC (501), a background radio frequency (RF) power level of a communication channel between the WNC (501) and the one or more MMS (503). Determining (504), by the WNC (501), a background radio frequency (RF) power level of a communication channel between the WNC (501) and the one or more MMS (503) may be carried out by the WNC (501) measuring the RF power level of a received signal at a time when a packet is not expected. For example, if a packet is expected from the MMS (503) every 2 seconds, the background RF power level (the “P_{BG}”) may be measured by the WNC (501) at a time between that interval. For example, the P_{BG} may be measured at time (i.e., slot) that is reserved for channel access for BMS commands.

In addition, the method of FIG. 5 also includes based on the determined background RF power level, selecting (506), by the WNC (501), one or more actions to perform in an attempt to correct the failure in communication between the WNC (501) and the one or more MMS (503). Selecting (506) based on the determined background RF power level, by the WNC (501), one or more actions to perform in an attempt to correct the failure in communication between the WNC (501) and the one or more MMS (503) may be carried out determining whether the background RF power level exceeds a particular threshold; determining whether determining whether the background RF power level is below another threshold; in response to determining that the background RF power level exceeds the particular threshold, selecting one set of actions; and in response to determining that the background RF power is below the other threshold, selecting another set of actions.

The method of FIG. 5 includes performing (508), by the WNC (501), the selected one or more actions in an attempt to correct the failure in communication. Performing (508), by the WNC (501), the selected one or more actions in an attempt to correct the failure in communication may be carried out by the WNC performing one or more of: switching from one communication channel to a redundant communication channel for communication with the one or more MMS; increasing the RF transceiver power of the WNC; and increasing the RF transceiver power of the one or more MMS.

By utilizing the background RF power level to select one or more activities to perform in an attempt to correct the failure in communication within the BMS, the WNC may have a chance of identifying activities that have the best chance of correcting the failure. Performing the selected one or more activities may resolve the failure, such that communication between the WNC and the one or more MMS may resume before a fault tolerant time interval for the vehicle expires. In such instances, the failure in communication is resolved without needing to place the vehicle in a safe operating state.

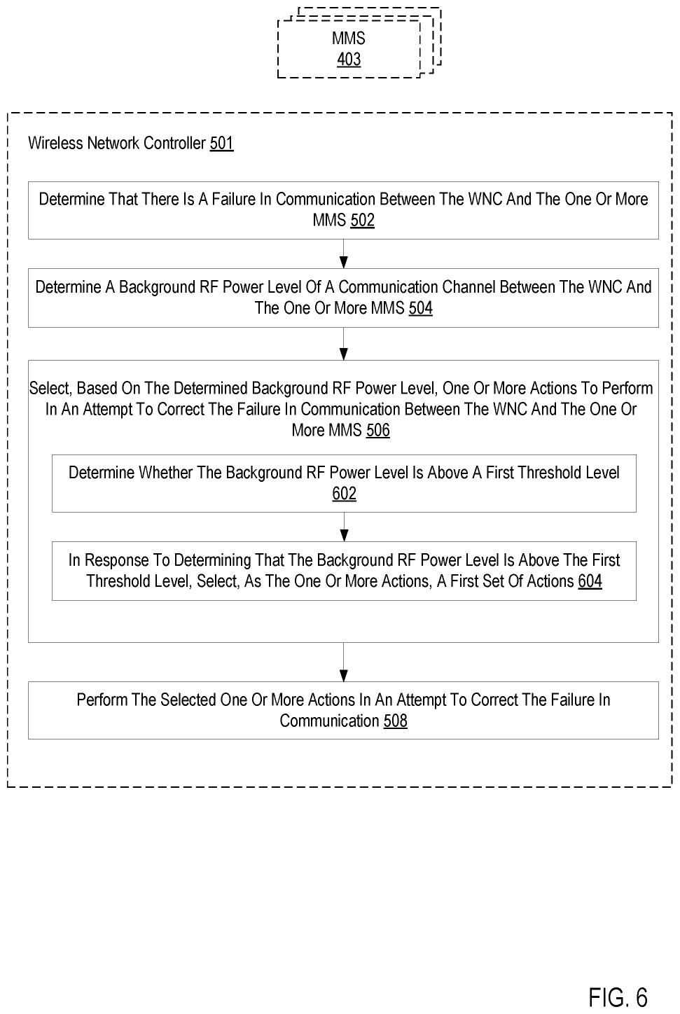

For further explanation, FIG. 6 sets forth a flowchart to illustrate an implementation of a method of resolving a failure in communication within a wireless battery management system in accordance with at least one embodiment of the present disclosure. The method of FIG. 6 is similar to the method of FIG. 5 in that the method of FIG. 6 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication.

However, in the method of FIG. 6, selecting (506) based on the determined background RF power level, by the WNC (501), one or more actions to perform in an attempt to correct the failure in communication between the WNC (501) and the one or more MMS (503) includes determining (602) whether the background RF power level is above a first threshold level. Determining (602) whether the background RF power level is above a first threshold level may be carried out by comparing the background RF power level to a predetermined power level; and comparing the background RF power level to a value that is based on a recorded RSSI value of one or more MMS.

In addition, selecting (506), based on the determined background RF power level, by the WNC (501), one or more actions to perform in an attempt to correct the failure in communication between the WNC (501) and the one or more MMS (503) includes in response to determining that the background RF power level is above the first threshold level, selecting (604), as the one or more actions, a first set of actions. Selecting (604), as the one or more actions, a first set of actions, in response to determining that the background RF power level is above the first threshold level may be carried out by switching to a redundant communication channel to avoid exceeding the FTTI.

In a particular embodiment, the first threshold level may be based on the recorded RSSI of incoming packets from the one or more MMSs (the “P_{RX}”). The P_{RX} may be, for example, the recorded RSSI value of a packet from one MMS, an average of RSSI values from one MMS, an average of RSSI values from multiple MMSs, or a maximum recorded RSSI value. When the background RF power level (the “P_{BG}”) is equal to or greater than the first threshold, the likelihood that the loss of communication is temporary may be highly probable. The first threshold may be, for example, the P_{RX}. Thus, when P_{BG}>=P_{RX} the probability the loss of communication may be high. The likelihood that the loss of communication is temporary may be highly probable in that it is highly probable that the loss of communication is due to signal interference. Thus, the interfering signal may cease or move away from the vehicle, the vehicle may move away from the interfering signal, or the DoS attack may abate, thus the loss of communication could be remedied before the FTTI elapses.

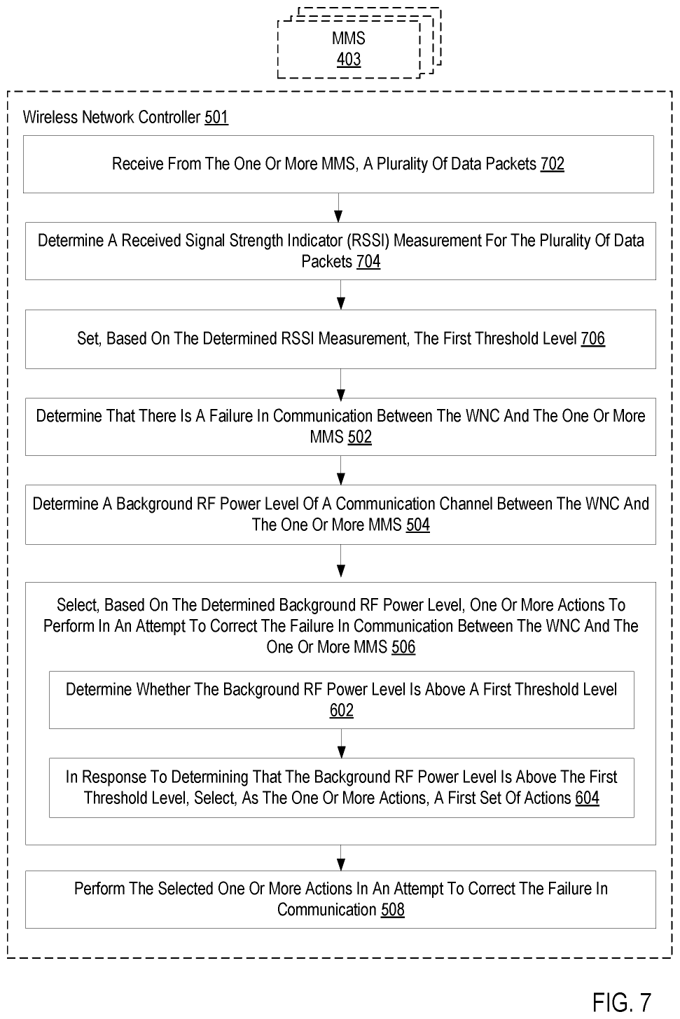

For further explanation, FIG. 7 sets forth a flowchart to illustrate an implementation of a method of resolving a failure in communication within a wireless battery management system in accordance with at least one embodiment of the present disclosure. The method of FIG. 7 is similar to the method of FIG. 6 in that the method of FIG. 7 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (602) whether the background RF power level is above a first threshold level; and in response to determining that the background RF power level is above the first threshold level, selecting (604), as the one or more actions, a first set of actions.

However, unlike the method of FIG. 6, the method of FIG. 7 includes receiving (702) from the one or more MMS (503), by the WNC (501), a plurality of data packets. Receiving (702) from the one or more MMS (503), by the WNC (501), a plurality of data packets may be carried out by receiving via the wireless communication channel, packets at a wireless network adapter of the WNC.

In addition, the method of FIG. 7 also includes determining (704), by the WNC (501), a received signal strength indicator (RSSI) measurement for the plurality of data packets. Determining (704), by the WNC (501), a received signal strength indicator (RSSI) measurement for the plurality of data packets may be carried out by the WNC (501) measuring and recording the RSSI of incoming packets received from the one or more MMS (503). For example, the WNC (501) may receive packets from the MMS (503) at a regular interval (e.g., every 2 seconds). The packets are transmitted via a radio frequency (RF) link and received by the WNC (501).

Furthermore, the method of FIG. 7 includes setting (706), based on the determined RSSI measurement, by the WNC (501), the first threshold level. Setting (706), based on the determined RSSI measurement, by the WNC (501), the first threshold level may be carried out by storing the RSSI measurement as the first threshold; storing as the first threshold, the RSSI measurement plus a first additional value; storing as the first threshold, the RSSI measurement minus a second additional value.

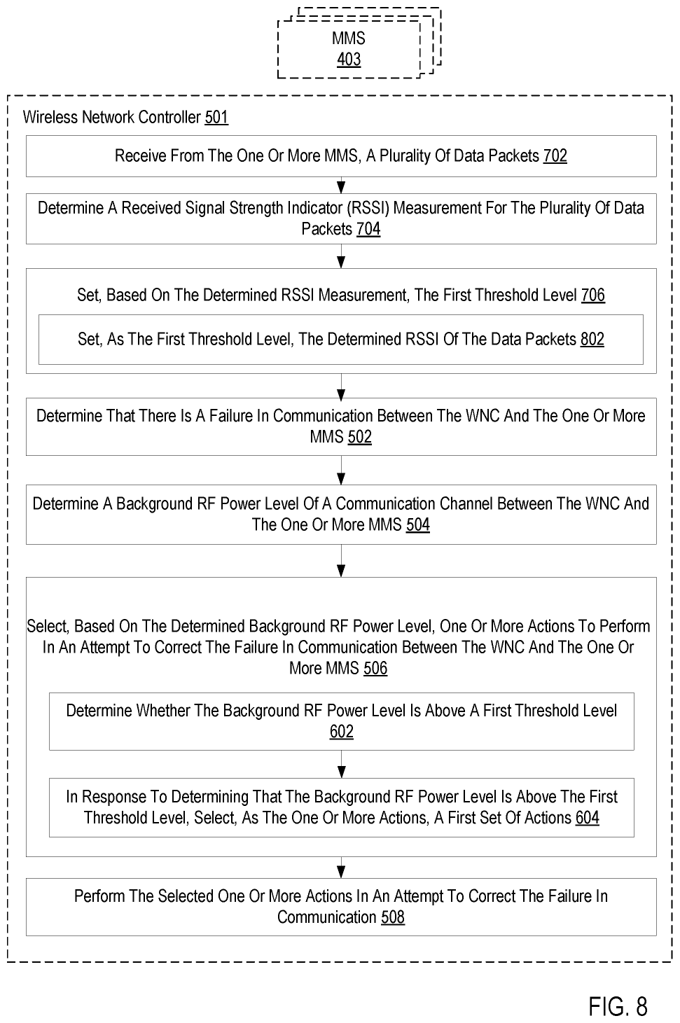

For further explanation, FIG. 8 sets forth a flowchart to illustrate an implementation of a method of resolving a failure in communication within a wireless battery management system in accordance with at least one embodiment of the present disclosure. The method of FIG. 8 is similar to the method of FIG. 7 in that the method of FIG. 8 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); performing (508), by the WNC (501), the selected one or more actions in an attempt to correct the failure in communication; receiving (702) from the one or more MMS (503), by the WNC (501), a plurality of data packets; determining (704), by the WNC (501), a received signal strength indicator (RSSI) measurement for the plurality of data packets; and setting (706), based on the determined RSSI measurement, by the WNC (501), the first threshold level; wherein based on the determined background RF power level, selecting (506), by the WNC (501), one or more actions to perform in an attempt to correct the failure in communication between the WNC (501) and the one or more MMS (503) includes determining (602) whether the background RF power level is above a first threshold level; and in response to determining that the background RF power level is above the first threshold level, selecting (604), as the one or more actions, a first set of actions.

In the method of FIG. 8, setting (706), based on the determined RSSI measurement, by the WNC (501), the first threshold level includes setting (802), as the first threshold level, the determined RSSI of the data packets. Setting (802), as the first threshold level, the determined RSSI of the data packets may be carried out by storing the RSSI measurement as the first threshold.

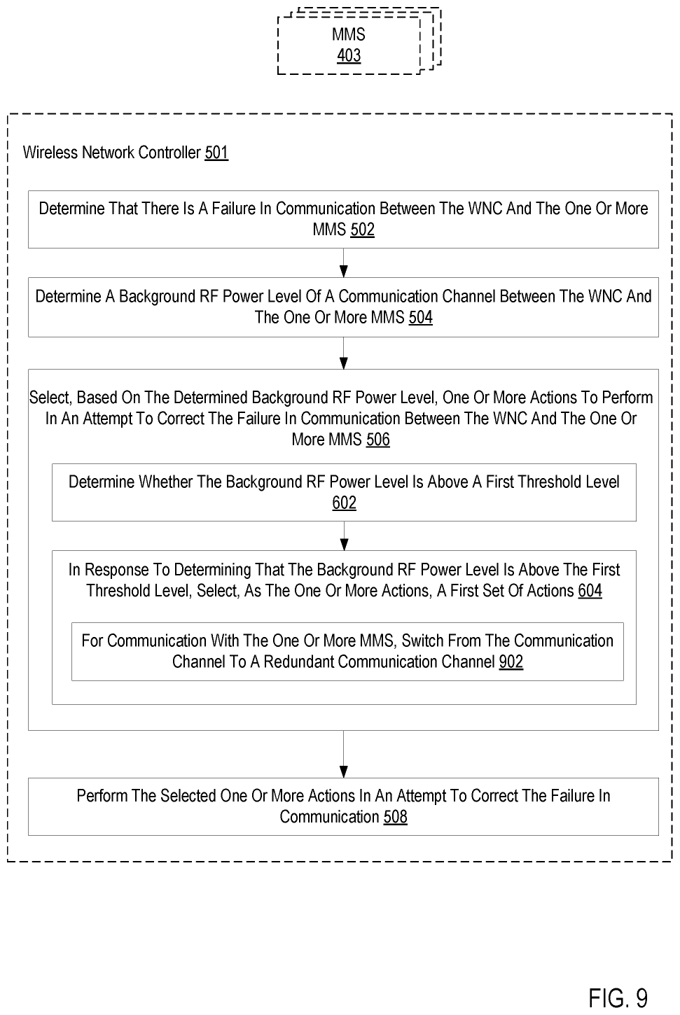

For further explanation, FIG. 9 sets forth a flowchart to illustrate an implementation of a method of resolving a failure in communication within a wireless battery management system in accordance with at least one embodiment of the present disclosure. The method of FIG. 9 is similar to the method of FIG. 6 in that the method of FIG. 9 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (602) whether the background RF power level is above a first threshold level; and in response to determining that the background RF power level is above the first threshold level, selecting (604), as the one or more actions, a first set of actions.

In the method of FIG. 9, the first set of actions may include: for communication with the one or more MMS (503), switching (902), by the WNC (501), from the communication channel to a redundant communication channel. Switching (902), by the WNC (501), from the communication channel to a redundant communication channel may be carried out by sending an indication to the one or MMS to switch to the redundant communication channel; switching to the redundant communication channel without instructing the MMS; utilizing the redundant communication channel to transmit packets to the one or more MMS; and receiving from the one or more MMS, packets on the redundant communication channel.

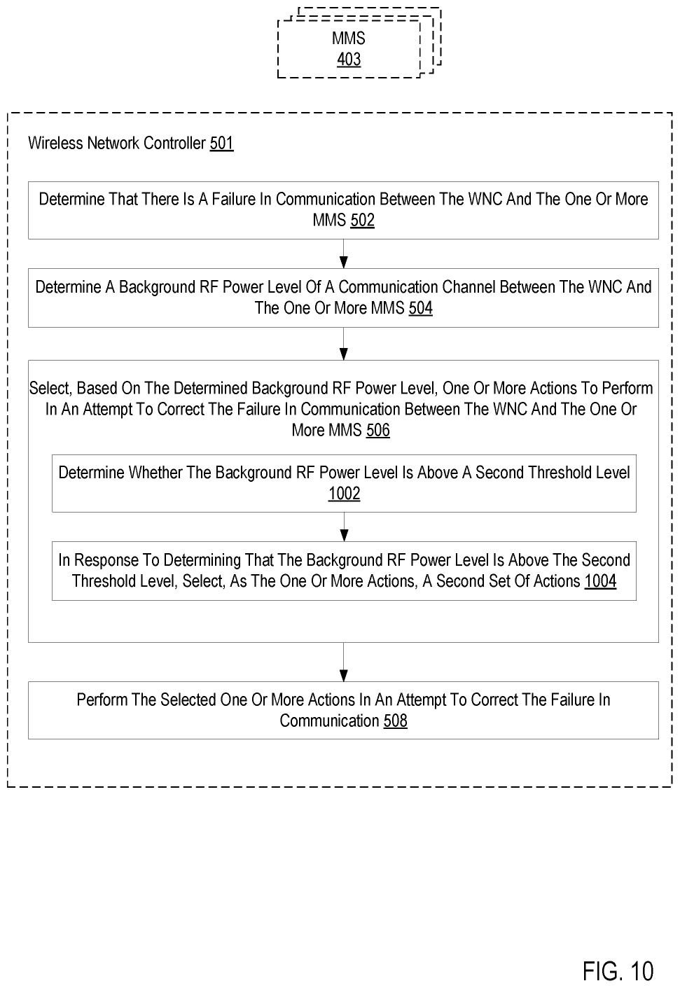

For further explanation, FIG. 10 sets forth a flowchart to illustrate an implementation of a method of resolving a failure in communication within a wireless battery management system in accordance with at least one embodiment of the present disclosure. The method of FIG. 10 is similar to the method of FIG. 5 in that the method of FIG. 10 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication.

However, in the method of FIG. 10, selecting (506), based on the determined background RF power level, by the WNC (501), one or more actions to perform in an attempt to correct the failure in communication between the WNC (501) and the one or more MMS (503) includes determining (1002) whether the background RF power level is above a second threshold level. Determining (1002) whether the background RF power level is above a second threshold level may be carried out by comparing the background RF power level to a predetermined power level; and comparing the background RF power level to a value that is based on a recorded RSSI value of one or more MMS.

In addition, selecting (506), based on the determined background RF power level, by the WNC (501), one or more actions to perform in an attempt to correct the failure in communication between the WNC (501) and the one or more MMS (503) includes in response to determining that the background RF power level is above the second threshold level, selecting (1004), as the one or more actions, a second set of actions. Selecting (1004), as the one or more actions, a second set of actions in response to determining that the background RF power level is above the second threshold level may be carried out by increasing a RF power level of the WNC; increasing a RF power level of the one or more MMS; and sending an indication to the one or more MMS to increase the RF power level.

In a particular embodiment, when the P_{BG} is less than the P_{RX} (e.g., the first threshold) but greater than or equal to the second threshold, it may be reasonably probable that the loss of communication is temporary (e.g., due to signal interference). For example, the second threshold may be the P_{RX} less a power factor, such as P_{RX}−M dBm. For example, M may be equal to 6 dBm. In such a scenario where P_{BG}<P_{RX} but P_{BG}>=P_{RX}−M dBm, there may be a reasonable probability that the loss of communication is temporary.

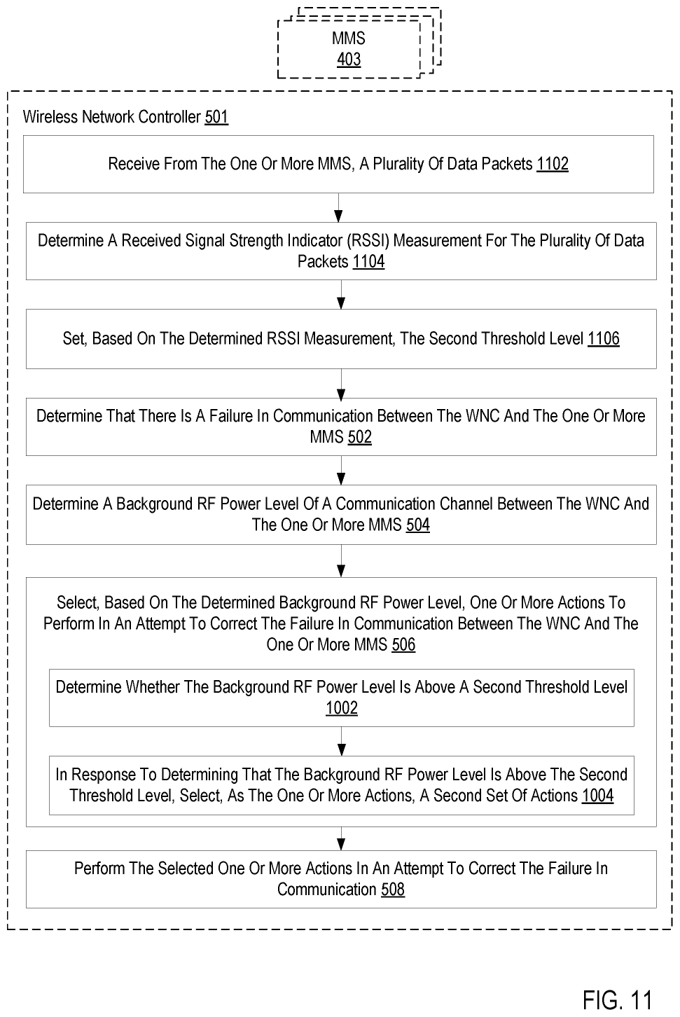

For further explanation, FIG. 11 sets forth a flowchart to illustrate an implementation of a method of resolving a failure in communication within a wireless battery management system in accordance with at least one embodiment of the present disclosure. The method of FIG. 11 is similar to the method of FIG. 10 in that the method of FIG. 11 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (1002) whether the background RF power level is above a second threshold level; and in response to determining that the background RF power level is above the second threshold level, selecting (1004), as the one or more actions, a second set of actions.

In addition, the method of FIG. 11 also includes receiving (1102) from the one or more MMS (503), by the WNC (501), a plurality of data packets. Receiving (1102) from the one or more MMS (503), by the WNC (501), a plurality of data packets may be carried out by receiving via the wireless communication channel packets at a wireless network adapter of the WNC.

The method of FIG. 11 also includes determining (1104), by the WNC (501), a received signal strength indicator (RSSI) measurement for the plurality of packets. Determining (1104), by the WNC (501), a received signal strength indicator (RSSI) measurement for the plurality of packets may be carried out by the WNC (501) measuring and recording the RSSI of incoming packets received from the one or more MMS (503). For example, the WNC (501) may receive packets from the MMS (503) at a regular interval (e.g., every 2 seconds). The packets are transmitted via a radio frequency (RF) link and received by the WNC (501).

Furthermore, the method of FIG. 11 also includes setting (1106), based on the determined RSSI measurement, by the WNC (501), the second threshold level. Setting (1106), based on the determined RSSI measurement, by the WNC (501), the second threshold level may be carried out by storing as the second threshold, the RSSI measurement plus a first additional value; storing as the second threshold, the RSSI measurement minus a second additional value. For example, the second threshold may be the P_{RX} less a power factor, such as P_{RX}−M dBm. For example, M may be equal to 6 dBm. In such a scenario where P_{BG}<P_{RX} but P_{BG}>=P_{RX}−M dBm, there may be a reasonable probability that the loss of communication is temporary.

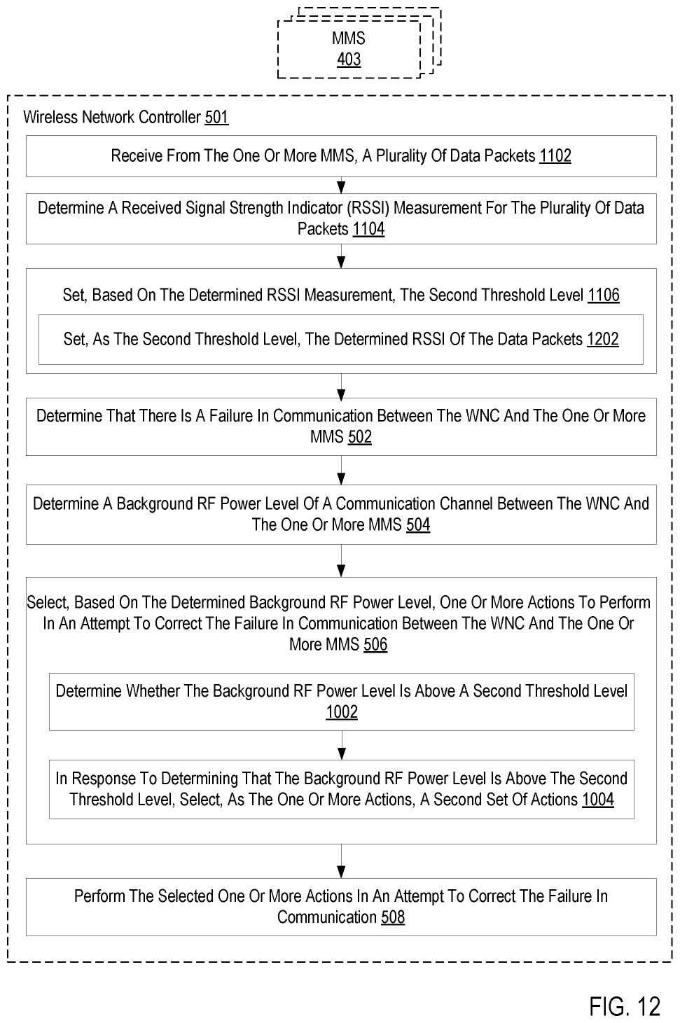

For further explanation, FIG. 12 sets forth a flowchart to illustrate an implementation of a method of resolving a failure in communication within a wireless battery management system in accordance with at least one embodiment of the present disclosure. The method of FIG. 12 is similar to the method of FIG. 11 in that the method of FIG. 12 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (1002) whether the background RF power level is above a second threshold level; and in response to determining that the background RF power level is above the second threshold level, selecting (1004), as the one or more actions, a second set of actions. In addition, like the method of FIG. 11, the method of FIG. 12 also includes receiving (1102) from the one or more MMS (503), by the WNC (501), a plurality of data packets; determining (1104), by the WNC (501), a received signal strength indicator (RSSI) measurement for the plurality of packets; and setting (1106), based on the determined RSSI measurement, by the WNC (501), the second threshold level.

In the method of FIG. 12, setting (1106), based on the determined RSSI measurement, by the WNC (501), the second threshold level includes setting (1202), as the second threshold level, the difference between the determined RSSI of the data packets and a first predetermined power level. Setting (1202), as the second threshold level, the difference between the determined RSSI of the data packets and a first predetermined power level may be carried out by determining the difference between the determined RSSI of the data packets and a first predetermined power level; and storing the determined difference as the second threshold.

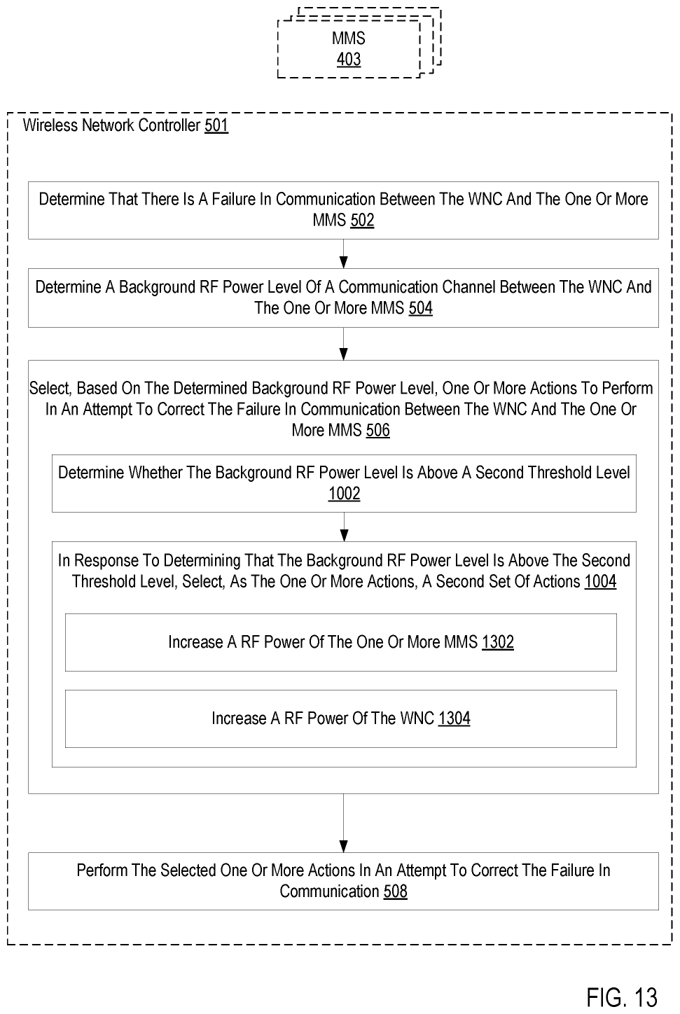

For further explanation, FIG. 13 sets forth a flowchart to illustrate an implementation of a method of resolving a failure in communication within a wireless battery management system in accordance with at least one embodiment of the present disclosure. The method of FIG. 13 is similar to the method of FIG. 10 in that the method of FIG. 13 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (1002) whether the background RF power level is above a second threshold level; and in response to determining that the background RF power level is above the second threshold level, selecting (1004), as the one or more actions, a second set of actions.

In the example of FIG. 13, the second set of actions include increasing (1302) a radio frequency power of the one or more MMS (503); and increasing (1304) a radio frequency power of the WNC (501). Increasing (1302) a radio frequency power of the one or more MMS (503) and increasing (1304) a radio frequency power of the WNC (501) may be carried out by sending an instruction to the one or more MMS to increase the RF transceiver power; and instructing a wireless transceiver of the WNC to utilize more power when transmitting and receiving with the one or more MMS.

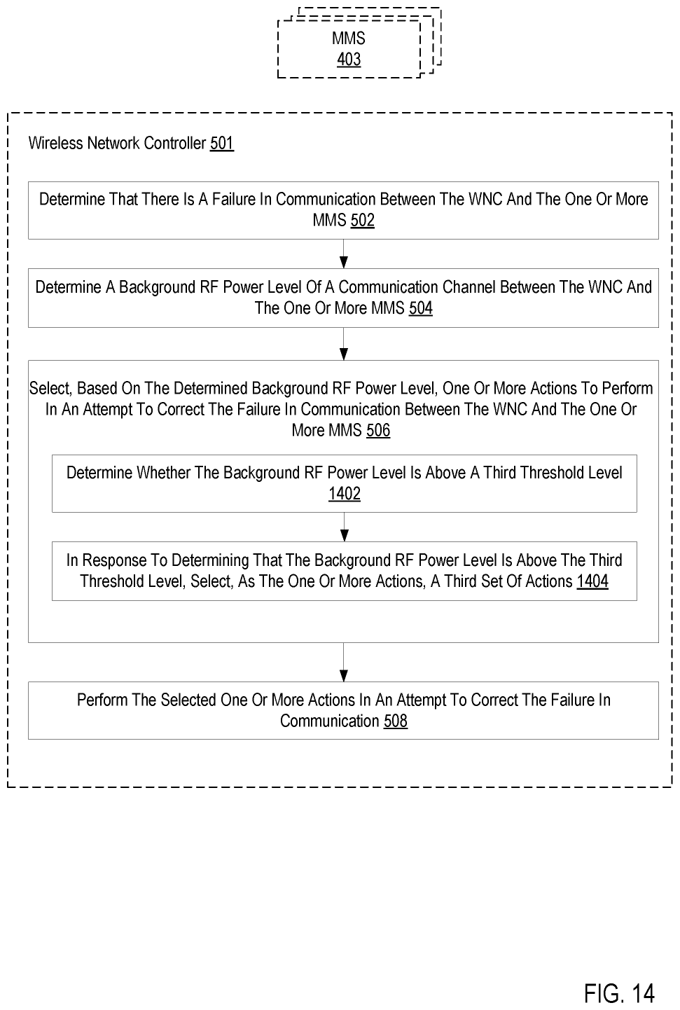

For further explanation, FIG. 14 sets forth a flowchart to illustrate an implementation of a method of resolving a failure in communication within a wireless battery management system in accordance with at least one embodiment of the present disclosure. The method of FIG. 14 is similar to the method of FIG. 5 in that the method of FIG. 14 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication.

In the method of FIG. 14, based on the determined background RF power level, selecting (506), by the WNC (501), one or more actions to perform in an attempt to correct the failure in communication between the WNC (501) and the one or more MMS (503) includes determining (1402) whether the background RF power level is below a third threshold level. Determining (1402) whether the background RF power level is below a third threshold level may be carried out by comparing the background RF power level to a predetermined power level; and comparing the background RF power level to a value that is based on a measured RSSI value of the one or more MMS.

In addition, in the method of FIG. 14, based on the determined background RF power level, selecting (506), by the WNC (501), one or more actions to perform in an attempt to correct the failure in communication between the WNC (501) and the one or more MMS (503) includes in response to determining that the background RF power level is below the third threshold level, selecting (1404), as the one or more actions, a third set of actions. Selecting (1404), as the one or more actions, a third set of actions in response to determining that the background RF power level is below the third threshold level may be carried out by increasing a RF power level of the WNC; increasing a RF power level of the one or more MMS; sending an indication to the one or more MMS to increase the RF power level; and switching to a redundant communication channel to avoid exceeding the FTTI.

In a particular embodiment, when the P_{BG} is less than the third threshold, the likelihood that the loss of communication is temporary may be improbable. For example, the third threshold may be the P_{RX} less another power factor, such as P_{RX}−N dBm. For example, N may be equal to 10 dBm. In such a scenario where P_{BG}<P_{RX}−N dBm, it may be inferred that an interfering signal is not the cause of the loss of communication, and rather that the loss of communication is more likely due to a hardware failure.

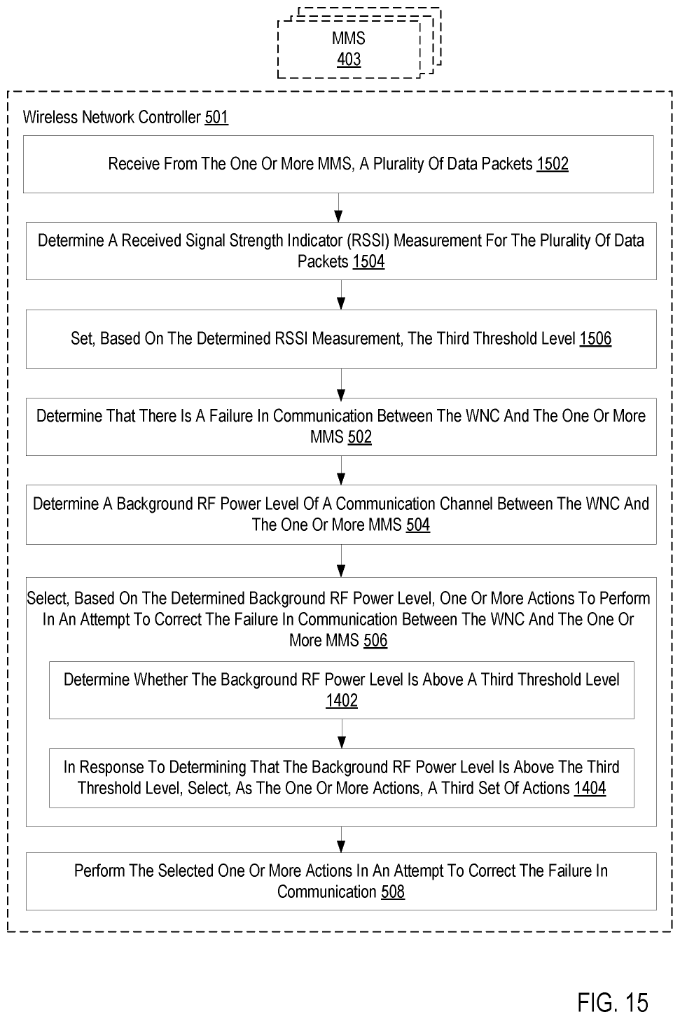

For further explanation, FIG. 15 sets forth a flowchart to illustrate an implementation of a method of resolving a failure in communication within a wireless battery management system in accordance with at least one embodiment of the present disclosure. The method of FIG. 15 is similar to the method of FIG. 14 in that the method of FIG. 15 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (1402) whether the background RF power level is below a third threshold level; and in response to determining that the background RF power level is below the third threshold level, selecting (1404), as the one or more actions, a third set of actions.

However, the method of FIG. 15 also includes receiving (1502) from the one or more MMS (503), by the WNC (501), a plurality of data packets. Receiving (1502) from the one or more MMS (503), by the WNC (501), a plurality of data packets may be carried out by receiving via the wireless communication channel, packets at a wireless network adapter of the WNC.

In addition, the method of FIG. 15 also includes determining (1504), by the WNC (501), a received signal strength indicator (RSSI) measurement for the plurality of packets. Determining (1504), by the WNC (501), a received signal strength indicator (RSSI) measurement for the plurality of packets may be carried out by the WNC (501) measuring and recording the RSSI of incoming packets received from the one or more MMS (503). For example, the WNC (501) may receive packets from the MMS (503) at a regular interval (e.g., every 2 seconds). The packets may be transmitted via a radio frequency (RF) link and received by the WNC (501).

Furthermore, the method of FIG. 15 also includes setting (1506), based on the determined RSSI measurement, by the WNC (501), the third threshold level. Setting (1506), based on the determined RSSI measurement, by the WNC (501), the third threshold level may be carried out by storing as the third threshold, the RSSI measurement plus a first additional value; storing as the third threshold, the RSSI measurement minus a second additional value.

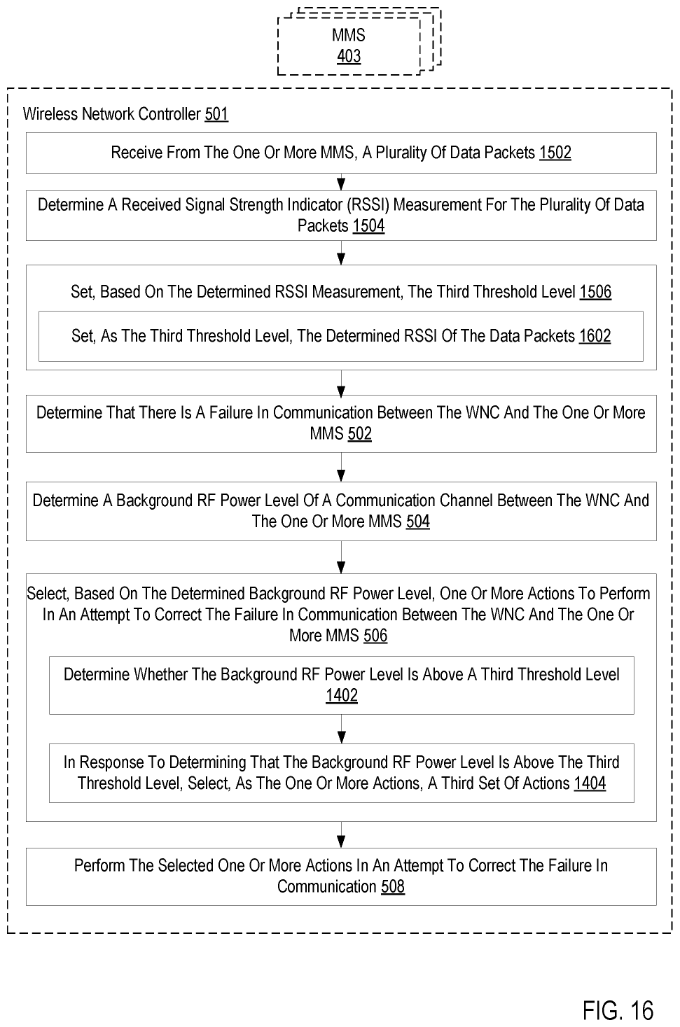

For further explanation, FIG. 16 sets forth a flowchart to illustrate an implementation of a method of resolving a failure in communication within a wireless battery management system in accordance with at least one embodiment of the present disclosure. The method of FIG. 16 is similar to the method of FIG. 15 in that the method of FIG. 16 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503), based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (1402) whether the background RF power level is below a third threshold level; and in response to determining that the background RF power level is below the third threshold level, selecting (1404), as the one or more actions, a third set of actions. In addition, like the method of FIG. 15, the method of FIG. 16 also includes receiving (1502) from the one or more MMS (503), by the WNC (501), a plurality of data packets; determining (1504), by the WNC (501), a received signal strength indicator (RSSI) measurement for the plurality of packets; and setting (1506), based on the determined RSSI measurement, by the WNC (501), the third threshold level.

In the method of FIG. 16, setting (1506), based on the determined RSSI measurement, by the WNC (501), the third threshold level includes setting (1602), as the second threshold level, the difference between the determined RSSI of the data packets and a first predetermined power level. Setting (1602), as the second threshold level, the difference between the determined RSSI of the data packets and a first predetermined power level may be carried out by determining the difference between the determined RSSI of the data packets and the first predetermined power level; and storing the determined difference as the third threshold.

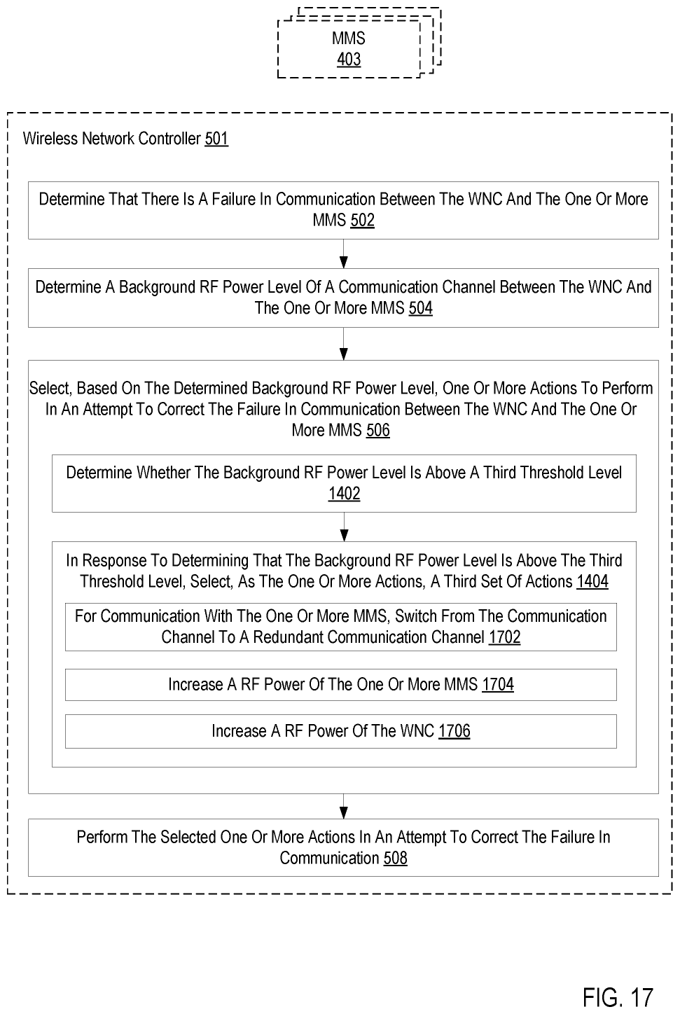

For further explanation, FIG. 17 sets forth a flowchart to illustrate an implementation of a method of resolving a failure in communication within a wireless battery management system in accordance with at least one embodiment of the present disclosure. The method of FIG. 17 is similar to the method of FIG. 14 in that the method of FIG. 17 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication; wherein based on the determined background RF power level, selecting (506), by the WNC (501), one or more actions to perform in an attempt to correct the failure in communication between the WNC (501) and the one or more MMS (503) includes determining (1402) whether the background RF power level is below a third threshold level; and in response to determining that the background RF power level is below the third threshold level, selecting (1404), as the one or more actions, a third set of actions.

In the example of FIG. 17, the third set of actions includes for communication with the one or more MMS (503), switching (1702), by the WNC (501), from the communication channel to a redundant communication channel; increasing (1704) a radio frequency power of the one or more MMS (503); and increasing (1706) a radio frequency power of the WNC (501). Switching (1702), by the WNC (501), from the communication channel to a redundant communication channel may be carried out by sending an indication to the one or MMS to switch to the redundant communication channel; switching to the redundant communication channel without instructing the MMS; utilizing the redundant communication channel to transmit packets to the one or more MMS; and receiving from the one or more MMS, packets on the redundant communication channel.

Increasing (1704) a radio frequency power of the one or more MMS (503) and increasing (1706) a radio frequency power of the WNC (501) may be carried out by sending an instruction to the one or more MMS to increase the RF power used to transmit the received wireless signal; and instructing a wireless transceiver of the WNC to utilize more power when transmitting and receiving with the one or more MMS.

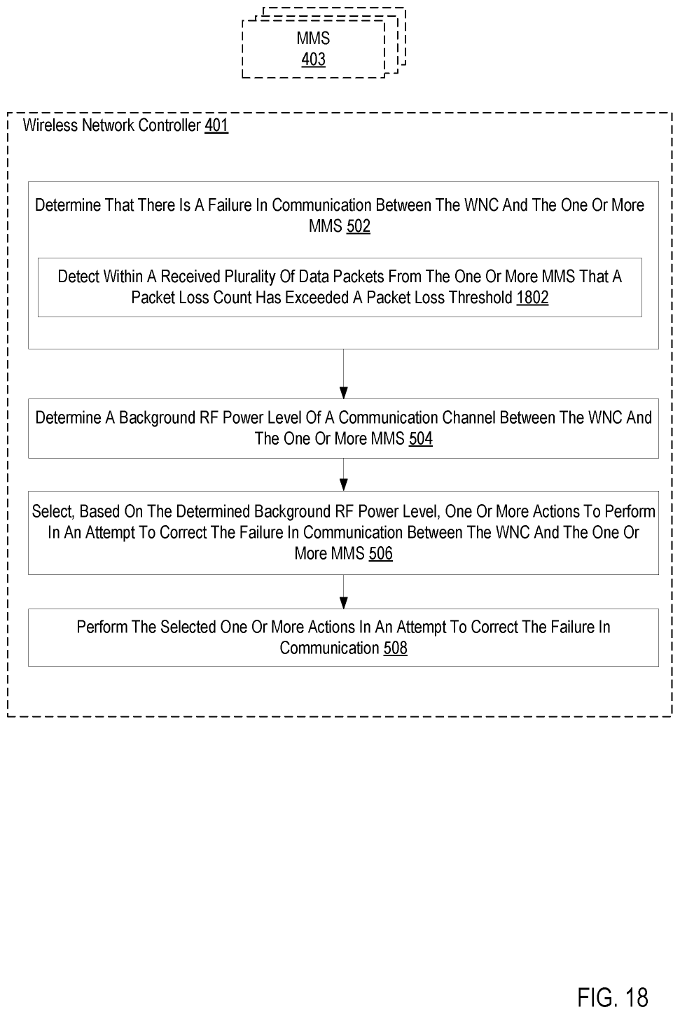

For further explanation, FIG. 18 sets forth a flowchart to illustrate an implementation of a method of resolving a failure in communication within a wireless battery management system in accordance with at least one embodiment of the present disclosure. The method of FIG. 18 is similar to the method of FIG. 5 in that the method of FIG. 18 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication.

In the method of FIG. 18, determining (502), by the WNC (501), that there is a failure in communication between the WNC (501) and the one or more MMS (503) includes detecting (1802), within a received plurality of data packets from the one or more MMS (503), that a packet loss count has exceeded a packet loss threshold. Detecting (1802), within a received plurality of data packets from the one or more MMS (503), that a packet loss count has exceeded a packet loss threshold may be carried out by the WNC (401) establishing a packet loss threshold (e.g., packet loss=3) that avoids exceeding a fault tolerant time interval (FTTI), and the WNC (401) determining that the number of packets expected but not received has exceeded the packet loss threshold.

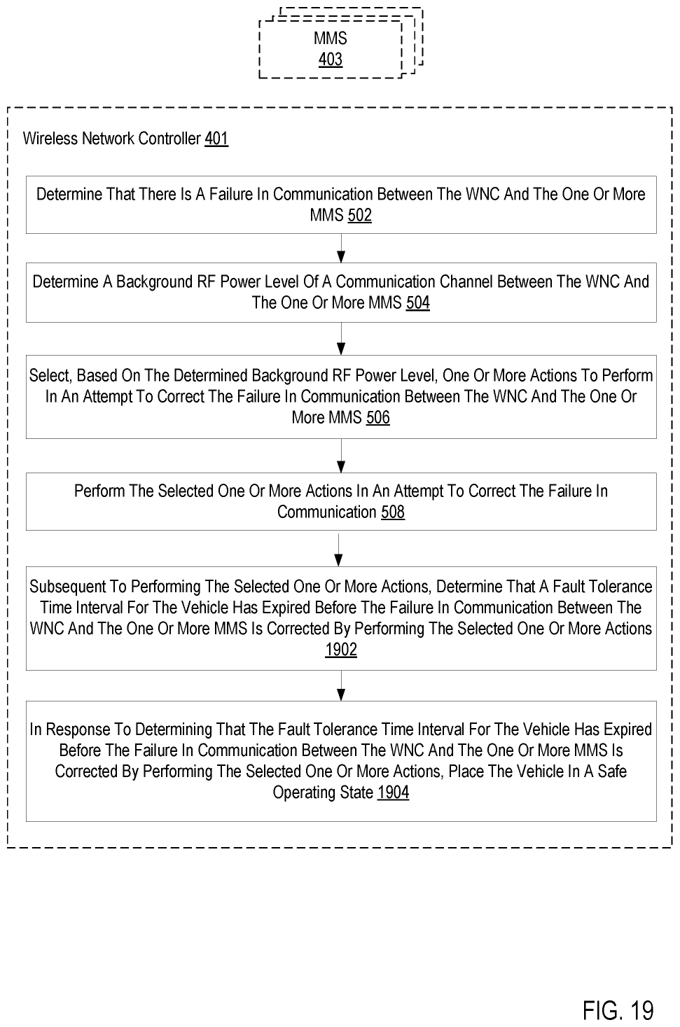

For further explanation, FIG. 19 sets forth a flowchart to illustrate an implementation of a method of resolving a failure in communication within a wireless battery management system in accordance with at least one embodiment of the present disclosure. The method of FIG. 18 is similar to the method of FIG. 5 in that the method of FIG. 18 also includes determining (502), by the WNC (501), that there is a failure in communication between the WNC (501) and the one or more MMS (503); determining (504), by the WNC (501), a background radio frequency (RF) power level of a communication channel between the WNC (501) and the one or more MMS (503); based on the determined background RF power level, selecting (506), by the WNC (501), one or more actions to perform in an attempt to correct the failure in communication between the WNC (501) and the one or more MMS (503); and performing (508), by the WNC (501), the selected one or more actions in an attempt to correct the failure in communication.

In addition, the method of FIG. 19 includes subsequent to performing the selected one or more actions, determining (1902), by the WNC (501), that a fault tolerance time interval for the vehicle has expired before the failure in communication between the WNC (501) and the one or more MMS (503) is corrected by performing the selected one or more actions. Subsequent to performing the selected one or more actions, determining (1902), by the WNC (501), that a fault tolerance time interval for the vehicle has expired before the failure in communication between the WNC (501) and the one or more MMS (503) is corrected by performing the selected one or more actions may be carried out by determining one or more packets have been received; determining whether the conditions regarding the receiving of the one or more packets satisfies the requirements for restarting the FTTI; in response to determining that the receiving of the one or more packets does not satisfy the requirements for restarting the FTTI, incrementing a counter for the FTTI; and determining that the counter for the FTTI is greater than a threshold of the FTTI.

Furthermore, the method of FIG. 19 includes in response to determining that the fault tolerance time interval for the vehicle has expired before the failure in communication between the WNC (501) and the one or more MMS (503) is corrected by performing the selected one or more actions, placing (1904) the vehicle in a safe operating state. Placing (1904) the vehicle in a safe operating state, in response to determining that the fault tolerance time interval for the vehicle has expired before the failure in communication between the WNC (501) and the one or more MMS (503) is corrected by performing the selected one or more actions may be carried out by sending an instruction to an electronic control unit (ECU) of a vehicle control system (VCS) that the FTTI has expired; and sending an instruction to an ECU to place the vehicle in the safe operating state.

In view of the explanations set forth above, readers will recognize that the benefits of determining a communication disruption for wireless battery management systems according to embodiments of the present invention include an improved wireless sensor system for vehicles that determines the type and/or potential cause of a communication failure, and determines whether the communication failure can be remedied before a FTTI elapses, as well as other benefits that will be appreciated by those of skill in the art.

Exemplary embodiments of the present invention are described largely in the context of a fully functional computer system for functional safety in a battery management system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the users computer, partly on the users computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method, apparatus, system, computer program product, non-transitory medium for resolving a failure in communication within a wireless battery management system (BMS) of a vehicle, the wireless BMS including a wireless network controller (WNC) and one or more module measurement system (MMS) that are configured to monitor a plurality of cells of a battery pack, the method, apparatus, system, computer program product, non-transitory medium comprising: determining, by the WNC, that there is a failure in communication between the WNC and the one or more MMS; determining, by the WNC, a background radio frequency (RF) power level of a communication channel between the WNC and the one or more MMS; based on the determined background RF power level, selecting, by the WNC, one or more actions to perform in an attempt to correct the failure in communication between the WNC and the one or more MMS; and performing, by the WNC, the selected one or more actions in an attempt to correct the failure in communication.

2. The method, apparatus, system, computer program product, non-transitory medium of statement 1, wherein based on the determined background RF power level, selecting, by the WNC, one or more actions to perform in an attempt to correct the failure in communication between the WNC and the one or more MMS includes: determining whether the background RF power level is above a first threshold level; and in response to determining that the background RF power level is above the first threshold level, selecting, as the one or more actions, a first set of actions.

3. The method, apparatus, system, computer program product, non-transitory medium of statement 1 or 2, further comprising receiving from the one or more MMS, by the WNC, a plurality of data packets; determining, by the WNC, a received signal strength indicator (RSSI) measurement for the plurality of data packets; and setting, based on the determined RSSI measurement, by the WNC, the first threshold level.

4. The method, apparatus, system, computer program product, non-transitory medium of any of statements 1-3, wherein setting, based on the determined RSSI measurement, the first threshold level includes: setting, as the first threshold level, the determined RSSI of the data packets.

5. The method, apparatus, system, computer program product, non-transitory medium of any of statements 1-4, wherein the first set of actions includes: for communication with the one or more MMS, switching, by the WNC, from the communication channel to a redundant communication channel.

6. The method, apparatus, system, computer program product, non-transitory medium of any of statements 1-5, wherein based on the determined background RF power level, selecting, by the WNC, one or more actions to perform in an attempt to correct the failure in communication between the WNC and the one or more MMS includes: determining whether the background RF power level is above a second threshold level; and in response to determining that the background RF power level is above the second threshold level, selecting, as the one or more actions, a second set of actions.

7. The method, apparatus, system, computer program product, non-transitory medium of any of statements 1-6 further comprising: receiving from the one or more MMS, by the WNC, a plurality of data packets; determining, by the WNC, a received signal strength indicator (RSSI) measurement for the plurality of packets; and setting, based on the determined RSSI measurement, by the WNC, the second threshold level.

8. The method, apparatus, system, computer program product, non-transitory medium of any of statements 1-7 wherein setting, based on the determined RSSI measurement, by the WNC, the second threshold level includes: setting, as the second threshold level, the difference between the determined RSSI of the data packets and a first predetermined power level.

9. The method, apparatus, system, computer program product, non-transitory medium of any of statements 1-8, wherein the second set of actions includes: increasing a radio frequency power of the one or more MMS; and increasing a radio frequency power of the WNC.

10. The method, apparatus, system, computer program product, non-transitory medium of any of statements 1-9, wherein based on the determined background RF power level, selecting, by the WNC, one or more actions to perform in an attempt to correct the failure in communication between the WNC and the one or more MMS includes: determining whether the background RF power level is below a third threshold level; and in response to determining that the background RF power level is below the third threshold level, selecting, as the one or more actions, a third set of actions.

11. The method, apparatus, system, computer program product, non-transitory medium of any of statements 1-10 further comprising: receiving from the one or more MMS, by the WNC, a plurality of data packets; determining, by the WNC, a received signal strength indicator (RSSI) measurement for the plurality of packets; and setting, based on the determined RSSI measurement, by the WNC, the third threshold level.

12. The method, apparatus, system, computer program product, non-transitory medium of any of statements 1-11 wherein setting, based on the determined RSSI measurement, by the WNC, the third threshold level includes: setting, as the third threshold level, the difference between the determined RSSI of the data packets and a second predetermined power level.

13. The method, apparatus, system, computer program product, non-transitory medium of any of statements 1-12, wherein the third set of actions includes: for communication with the one or more MMS, switching, by the WNC, from the communication channel to a redundant communication channel; increasing a radio frequency power of the one or more MMS; and increasing a radio frequency power of the WNC.

14. The method, apparatus, system, computer program product, non-transitory medium of any of statements 1-13, wherein determining, by the WNC, that there is a failure in communication between the WNC and the one or more MMS includes detecting, within a received plurality of data packets from the one or more MMS, that a packet loss count has exceeded a packet loss threshold.

15. The method, apparatus, system, computer program product, non-transitory medium of any of statements 1-14, further comprising: subsequent to performing the selected one or more actions, determining, by the WNC, that a fault tolerance time interval for the vehicle has expired before the failure in communication between the WNC and the one or more MMS is corrected by performing the selected one or more actions; and in response to determining that the fault tolerance time interval for the vehicle has expired before the failure in communication between the WNC and the one or more MMS is corrected by performing the selected one or more actions, placing the vehicle in a safe operating state.

16. A wireless battery management system (BMS) comprising: one or more module measurement systems (MMS), which are configured to monitor a plurality of cells of a battery pack; a wireless network controller (WNC) that includes a processor and memory operatively coupled to the processor, the memory having disposed within it computer program instructions that, when executed by the processor, cause the WNC to carry out the operations of: determining that there is a failure in communication between the WNC and the one or more MMS; determining a background radio frequency (RF) power level of a communication channel between the WNC and the one or more MMS; based on the determined background RF power level, selecting one or more actions to perform in an attempt to correct the failure in communication between the WNC and the one or more MMS; and performing the selected one or more actions in an attempt to correct the failure in communication.

17. The wireless BMS of statement 16, wherein based on the determined background RF power level, selecting one or more actions to perform in an attempt to correct the failure in communication between the WNC and the one or more MMS includes: determining whether the background RF power level is above a first threshold level; and in response to determining that the background RF power level is above the first threshold level, selecting, as the one or more actions, a first set of actions.

18. The wireless BMS of statements 16 or 17, wherein the first set of actions includes at least one of: for communication with the one or more MMS, switching from the communication channel to a redundant communication channel; increasing a radio power of the one or more MMS; and increasing a radio power of the WNC.

19. A non-transitory computer readable storage medium having computer program instructions that when executed by a processor of a wireless network controller (WNC) of a wireless battery management system (BMS), cause the WNC to carry out the operations of: determining that there is a failure in communication between WNC and one or more module measurement systems (MMS) of the wireless BMS, the one or more MMS configured to monitor a plurality of cells of a battery pack; determining a background radio frequency (RF) power level of a communication channel between the WNC and the one or more MMS; based on the determined background RF power level, selecting one or more actions to perform in an attempt to correct the failure in communication between the WNC and the one or more MMS; and performing the selected one or more actions in an attempt to correct the failure in communication.

20. The non-transitory computer readable storage medium of statement 19, wherein based on the determined background RF power level, selecting one or more actions to perform in an attempt to correct the failure in communication between the WNC and the one or more MMS includes: determining whether the background RF power level is above a first threshold level; and in response to determining that the background RF power level is above the first threshold level, selecting, as the one or more actions, at least one of: for communication with the one or more MMS, switching, by the WNC, from the communication channel to a redundant communication channel; increasing a radio power of the one or more MMS; and increasing a radio power of the WNC.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of resolving a failure in communication within a wireless battery management system (BMS) of a vehicle, the wireless BMS including a wireless network controller (WNC) and one or more module measurement system (MMS) that are configured to monitor a plurality of cells of a battery pack, the method comprising:
determining, by the WNC, that there is a failure in communication between the WNC and the one or more MMS;
determining, by the WNC, a background radio frequency (RF) power level of a communication channel between the WNC and the one or more MMS;
based on the determined background RF power level, selecting, by the WNC, one or more actions to perform in an attempt to correct the failure in communication between the WNC and the one or more MMS; and
performing, by the WNC, the selected one or more actions in an attempt to correct the failure in communication.

2. The method of claim 1 wherein based on the determined background RF power level, selecting, by the WNC, one or more actions to perform in an attempt to correct the failure in communication between the WNC and the one or more MMS includes:
determining whether the background RF power level is above a first threshold level; and
in response to determining that the background RF power level is above the first threshold level, selecting, as the one or more actions, a first set of actions.

3. The method of claim 2 further comprising:
receiving from the one or more MMS, by the WNC, a plurality of data packets;
determining, by the WNC, a received signal strength indicator (RSSI) measurement for the plurality of data packets; and
setting, based on the determined RSSI measurement, by the WNC, the first threshold level.

4. The method of claim 3 wherein setting, based on the determined RSSI measurement, the first threshold level includes:
setting, as the first threshold level, the determined RSSI of the data packets.

5. The method of claim 2, wherein the first set of actions includes: for communication with the one or more MMS, switching, by the WNC, from the communication channel to a redundant communication channel.

6. The method of claim 1 wherein based on the determined background RF power level, selecting, by the WNC, one or more actions to perform in an attempt to correct the failure in communication between the WNC and the one or more MMS includes:
determining whether the background RF power level is above a second threshold level; and
in response to determining that the background RF power level is above the second threshold level, selecting, as the one or more actions, a second set of actions.

7. The method of claim 6 further comprising:
receiving from the one or more MMS, by the WNC, a plurality of data packets;
determining, by the WNC, a received signal strength indicator (RSSI) measurement for the plurality of packets; and
setting, based on the determined RSSI measurement, by the WNC, the second threshold level.

8. The method of claim 7 wherein setting, based on the determined RSSI measurement, by the WNC, the second threshold level includes:
setting, as the second threshold level, the difference between the determined RSSI of the data packets and a first predetermined power level.

9. The method of claim 6, wherein the second set of actions includes:
increasing a radio frequency power of the one or more MMS; and
increasing a radio frequency power of the WNC.

10. The method of claim 1 wherein based on the determined background RF power level, selecting, by the WNC, one or more actions to perform in an attempt to correct the failure in communication between the WNC and the one or more MMS includes:
determining whether the background RF power level is below a third threshold level; and
in response to determining that the background RF power level is below the third threshold level, selecting, as the one or more actions, a third set of actions.

11. The method of claim 10 further comprising:
receiving from the one or more MMS, by the WNC, a plurality of data packets;
determining, by the WNC, a received signal strength indicator (RSSI) measurement for the plurality of packets; and
setting, based on the determined RSSI measurement, by the WNC, the third threshold level.

12. The method of claim 11 wherein setting, based on the determined RSSI measurement, by the WNC, the third threshold level includes:
setting, as the third threshold level, the difference between the determined RSSI of the data packets and a second predetermined power level.

13. The method of claim 10, wherein the third set of actions includes:
for communication with the one or more MMS, switching, by the WNC, from the communication channel to a redundant communication channel;
increasing a radio frequency power of the one or more MMS; and
increasing a radio frequency power of the WNC.

14. The method of claim 1 wherein determining, by the WNC, that there is a failure in communication between the WNC and the one or more MMS includes detecting, within a received plurality of data packets from the one or more MMS, that a packet loss count has exceeded a packet loss threshold.

15. The method of claim 1 further comprising:
subsequent to performing the selected one or more actions, determining, by the WNC, that a fault tolerance time interval for the vehicle has expired before the failure in communication between the WNC and the one or more MMS is corrected by performing the selected one or more actions; and
in response to determining that the fault tolerance time interval for the vehicle has expired before the failure in communication between the WNC and the one or more MMS is corrected by performing the selected one or more actions, placing the vehicle in a safe operating state.

16. A wireless battery management system (BMS) comprising:
one or more module measurement systems (MMS), which are configured to monitor a plurality of cells of a battery pack;
a wireless network controller (WNC) that includes a processor and memory operatively coupled to the processor, the memory having disposed within it computer program instructions that, when executed by the processor, cause the WNC to carry out the operations of:
determining that there is a failure in communication between the WNC and the one or more MMS;
determining a background radio frequency (RF) power level of a communication channel between the WNC and the one or more MMS;
based on the determined background RF power level, selecting one or more actions to perform in an attempt to correct the failure in communication between the WNC and the one or more MMS; and
performing the selected one or more actions in an attempt to correct the failure in communication.

17. The wireless BMS of claim 16 wherein based on the determined background RF power level, selecting one or more actions to perform in an attempt to correct the failure in communication between the WNC and the one or more MMS includes:
determining whether the background RF power level is above a first threshold level; and
in response to determining that the background RF power level is above the first threshold level, selecting, as the one or more actions, a first set of actions.

18. The wireless BMS of claim 17, wherein the first set of actions includes at least one of:
for communication with the one or more MMS, switching from the communication channel to a redundant communication channel;
increasing a radio power of the one or more MMS; and
increasing a radio power of the WNC.

19. A non-transitory computer readable storage medium having computer program instructions that when executed by a processor of a wireless network controller (WNC) of a wireless battery management system (BMS), cause the WNC to carry out the operations of:
determining that there is a failure in communication between WNC and one or more module measurement systems (MMS) of the wireless BMS, the one or more MMS configured to monitor a plurality of cells of a battery pack;
determining a background radio frequency (RF) power level of a communication channel between the WNC and the one or more MMS;
based on the determined background RF power level, selecting one or more actions to perform in an attempt to correct the failure in communication between the WNC and the one or more MMS; and
performing the selected one or more actions in an attempt to correct the failure in communication.

20. The non-transitory computer readable storage medium of claim 19 wherein based on the determined background RF power level, selecting one or more actions to perform in an attempt to correct the failure in communication between the WNC and the one or more MMS includes:
determining whether the background RF power level is above a first threshold level; and
in response to determining that the background RF power level is above the first threshold level, selecting, as the one or more actions, at least one of:
for communication with the one or more MMS, switching, by the WNC, from the communication channel to a redundant communication channel;
increasing a radio power of the one or more MMS; and
increasing a radio power of the WNC.
